(19) United States
(12) Patent Application Publication
(10) Pub. No.: US 2026/0129725 A1
(43) Pub. Date: May 7, 2026

(54) A MICROWAVE OVEN WITH A LIGHT SOURCE

(71) Applicant: V-ZUG AG, Zug (CH)

(72) Inventor: Robert KÜFFER, Ennetbürgen (CH)

(21) Appl. No.: 18/704,615

(22) PCT Filed: Oct. 26, 2021
(86) PCT No.: PCT/EP2021/079641

§ 371 Date: Apr. 25, 2024

(51) Int. Cl. H05B 6/64; H05B 6/74

(52) U.S. Cl. CPC H05B 6/6444; H05B 6/745

(57) ABSTRACT

A microwave oven includes a chamber (6) for receiving foodstuff. A microwave generator (20) feeds microwave radiation to the chamber (6) via a recess (14). A stirring wheel (24) is arranged in recess (14) for homogeneously distributing the microwave field in the chamber (6). A light source (28) is provided for illuminating the chamber (6). Its light passes through a light guide (30) extending through the recess (14) past stirrer wheel (24), thereby preventing the stirrer wheel (24) from affecting the illumination.

### CROSS-REFERENCE TO RELATED APPLICATION

This application is a National Stage application of International Patent Application No. PCT/EP2021/079641, filed on Oct. 26, 2021, which is hereby incorporated by reference in its entirety.

### TECHNICAL FIELD

The invention relates to a microwave oven with a light source.

### BACKGROUND

EP 2991451 describes a microwave oven with a light source. The microwave oven comprises a foodstuff chamber and a recess arranged in the top wall of the chamber. A microwave generator connected to recess feeds microwave radiation into the chamber.

The oven further comprises light sources arranged at the top and side wall of the recess.

Typically, microwave ovens are equipped with a turntable or a stirrer wheel to homogeneously distribute the microwave radiation within the chamber.

### SUMMARY

The problem to be solved by the present invention is to provide a microwave oven with an improved illumination.

This problem is solved by the microwave oven of claim 1.

Accordingly, the microwave oven comprises at least the following elements:
A foodstuff chamber: This is a microwave-tight chamber for receiving the foodstuff to be heated. Typically, it has the shape of a cuboid with a door at a front side for loading/unloading the foodstuff.
A recess arranged in a wall of the chamber: This recess forms a set-back region, which is typically located outside the cuboid of the chamber. The recess has a rear wall on a side opposite to the chamber and side walls connecting the rear wall to the chamber. The direction perpendicular to the chamber wall is designated as the “depth direction” and used to designate locations of components within the description and claims, with terms such as “deeper” or “at the same depth” referring to this depth direction. By definition, the rear wall is located deeper than the chamber wall.
A microwave generator connected to the recess: The microwave generator is adapted to generate microwave radiation and feed it, via the recess, to the chamber.
A stirrer wheel arranged in the recess between the rear wall and the chamber: The stirrer wheel is rotatable around an axis, typically by means of a stirrer wheel drive. The microwave oven may be adapted to rotate the stirrer wheel while feeding microwave radiation to the chamber in order to achieve a more homogeneous distribution of the radiation within the chamber.
A light source: The light source is positioned to feed light into the chamber.
A light guide extending from the light source through an opening in the rear wall or at least one of the side walls and into the recess: This light guide allows to place the light source away from the chamber, thereby reducing its exposure to heat and/or radiation.

The opening is located deeper than the stirrer wheel (i.e. farther away from the chamber) or at the same depth as the stirrer wheel (i.e. at the same distance from the chamber as at least parts of the stirrer wheel). In particular, the opening is farther away from the chamber than the blades of the stirrer wheel or at the same distance from the chamber as at least parts of the blades.

On the other hand, the chamber-facing end of the light guide is located such that the exit cone of the light emerging from the light guide is outside the space occupied by the stirrer wheel, i.e. it does not intersect with the motion of the rotating stirrer wheel. In other words, the exit cone does not intersect with the moving peripheral parts of the stirrer wheel.

In this context, the “exit cone” is the space volume around the exit axis of the light guide that includes at least 75%, in particular at least 90%, of the light directly emerging from the chamber-facing end of the light guide. (Note: Even though the term “cone” is used, the volume of the exiting light need not be exactly rotational symmetric if the light guide does not have circular but e.g. oval cross section.)

Hence, as seen along the axis of the light guide, the light guide extends over at least part of the stirrer wheel.

This design allows to carry the light past the stirrer wheel towards the chamber. Hence, the light emerging from the light guide is not significantly affected by the current position of the stirrer wheel, which reduces the flicker caused by the motion of the stirrer wheel and provides a more steady illumination within the chamber.

Advantageously, for easier assembly, the opening is located in the rear wall, i.e. the light guide passes through the rear wall.

Advantageously, the chamber-facing end of the light guide is at least as close to the chamber as the part of the blades of the stirrer wheel that is closest to the chamber.

In particular, the light guide enters the recess through an opening in the rear wall. The stirrer wheel (i.e. its rotating blades) is closer to the foodstuff chamber than said opening, i.e. the light guide carries the light from the rear side of the wheel (i.e. the side of the wheel facing away from the chamber) past the wheel.

Advantageously, the microwave oven further comprises a metallic shield member connected to the rear wall, wherein the light guide extends through an opening in the shield member. This reduces leakage of microwave radiation at the location of the light guide.

Advantageously, the shield member surrounds the light guide for a length of at least 1 cm, in particular at least 3 cm, along the axial direction of the light guide. This improves the dampening of the microwave radiation leaking into the opening.

The opening in the shield advantageously has a diameter much smaller than the wavelength of the microwave radiation, in particular a diameter smaller than 1 cm. Again, this reduces microwave leakage.

The light source may be mounted to the shield member, thereby rendering its correct placement easier.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 shows a first, schematic sectional view of a microwave oven,

FIG. 2 shows a second, schematic sectional view of a microwave oven,

FIG. 3 is a sectional view of the chamber and recess of an embodiment of a microwave oven,

FIG. 4 shows a first view of the recess and microwave generator of the device of FIG. 3,

FIG. 5 shows a second view of the recess and microwave generator of the device of FIG. 3,

FIG. 6 shows a bottom view of the recess and microwave generator of the device of FIG. 3,

FIG. 7 shows a sectional view along line F-F of FIG. 6,

FIG. 8 shows a schematic sectional view of a second embodiment of a microwave oven, and

FIG. 9 shows a schematic sectional view of a third embodiment of a microwave oven.

### DETAILED DESCRIPTION

### General

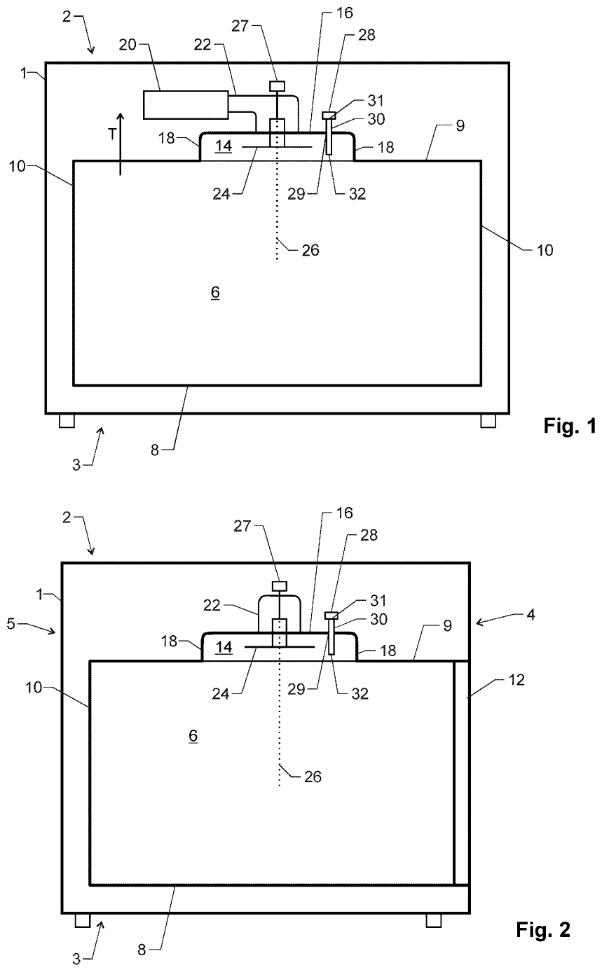

FIGS. 1 and 2 schematically show a microwave oven having a housing 1 that, in its operating position, has a top side 2, a bottom side 3, a user-facing front side 4, and a back side 5 opposite to front side 4.

The device has a foodstuff chamber 6 for receiving the foodstuff to be heated. Chamber 6 has a bottom chamber wall 8, a top chamber wall 9, and substantially vertical side chamber walls 10 extending between bottom chamber wall 8 and top chamber wall 9.

A door 12 is located at the front side 4 of the device and forms at least part of one of the side chamber walls 10 of chamber 6. It is used to load and unload the foodstuff.

A recess 14 is e.g. located in top chamber wall 9. It comprises a rear chamber wall 16, which is, in the present embodiment, located at a level above top chamber wall 9, as well as lateral walls 18 connecting rear wall 16 to top chamber wall 9.

FIG. 1 shows a depth direction T, which is defined as the direction perpendicular to chamber wall 9 and used herein for describing positions along this direction. Depth direction T is, by definition, pointing away from chamber 6, i.e. anything further away from chamber 6 than e.g. chamber wall 9 is considered to be located “deeper” than chamber wall 9.

Advantageously, rear chamber wall 16 is flat and may extend horizontally.

A microwave generator 20 is connected, via a hollow waveguide 22, to recess 14.

A stirrer wheel 24 is arranged in recess 24 between rear wall 16 and chamber 6. It is mounted to be rotatable about a vertical axis 26 and has one or more blades extending radially away from axis 26.

A stirrer drive 27 is connected to stirrer wheel 24 for rotating it about axis 26.

The oven further comprises a light source 28 for illuminating chamber 6. A light guide 30 extends from light source 28 downwards through an opening 29 in rear wall 16 into recess 14 past stirrer wheel 24.

Light guide 30 has a first, light-source-facing end 31 and a second, chamber-facing end 32. Light-source-facing end 31 is located such that light from light source 28 is coupled into light guide 30. Chamber-facing end 32 is located such that light from the light guide is emitted into chamber 6.

Chamber-facing end 32 is located such that the light emanating from it does not directly hit the blades of stirrer wheel 24, which allows to carry the light past stirrer wheel 24 as described above.

Advantageously, chamber-facing end 32 is at least as close as to chamber 6 as the blades of stirrer wheel 24, in particular closer to chamber 6 than the blades of stirrer wheel 24, in order to further reduce the effects of stirrer wheel 24 on the distribution of the light in chamber 6. In particular, chamber-facing end 32 is at least 1 mm closer to chamber 6 than the blades of stirrer wheel 24.

As seen in FIGS. 1 and 2, light guide 30 extends, at least within recess 14, along a direction parallel to axis 26 in order to guide the light in a substantially downward direction into chamber 6 as it exits the light guide.

Light guide 30 is located horizontally beside stirrer wheel 24 in the space between stirrer wheel 24 and the lateral walls 18.

In the shown example, light guide 30 is a straight rod extending from the light source into the recess, with its longitudinal axis advantageously extending vertically.

Light guide 30 may e.g. be of a transparent solid, in particular of glass in order to withstand the elevated temperatures in chamber 6.

### EXAMPLE

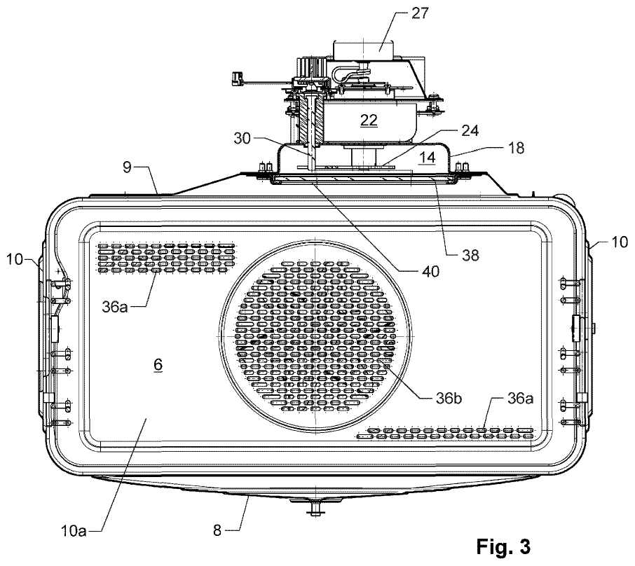

FIGS. 3-8 show an embodiment of a microwave oven using the present technology.

As best seen in FIG. 3, the device may comprise a resistive heater in addition to a microwave heating. In the shown embodiment, a forced-convection heater may e.g. be arranged behind back wall 10a of chamber 6, with openings 36a, 36b to let air pass between chamber 6 and the heater behind it.

Recess 14 is arranged in top chamber wall 9 of chamber 6. A transparent cover plate 38 is located between chamber 6 and recess 14. Cover plate 38 is advantageously of glass for better withstanding heat in chamber 6.

Cover plate 38 comprises a diffusor 40 for scattering the light, in particular diffusely scattering the light, from light guide 30. Diffuser 40 may e.g. be formed by surface structures on at least one of the surfaces of cover plate 38 and/or by scattering inhomogeneities within the material of cover plate 38.

Cover plate 38 extends horizontally and parallel to rear wall 16 of recess 14.

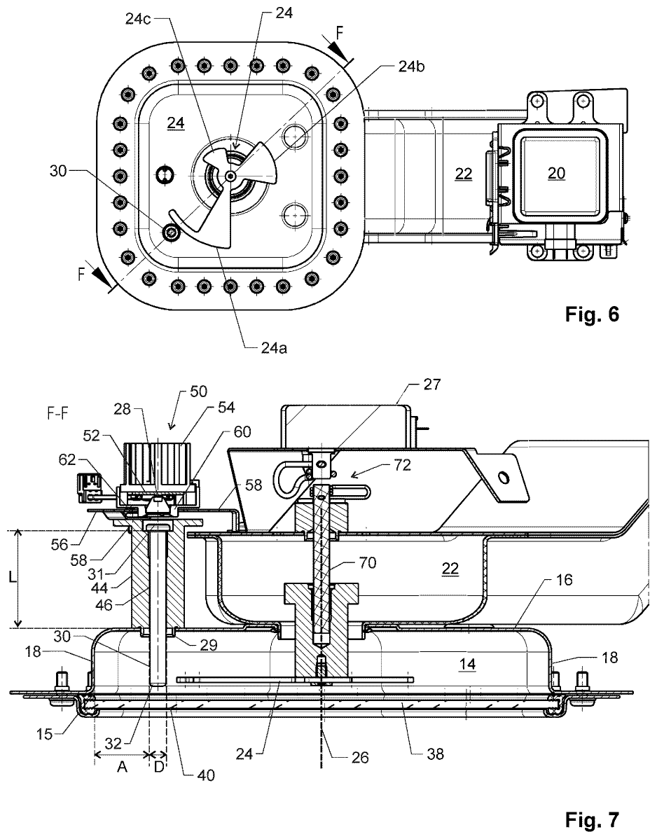

As shown in FIGS. 5 and 6, stirrer wheel 24 comprises several blades 24a, 24b, 24c, e.g. of different length and/or shape, in order to homogeneously distribute the microwave field as the wheel rotates. The blades 24a, 24b, 24 c advantageously extend radially away from axis 26.

Light guide 30 is arranged radially outside the blades of stirrer wheel 24 in order to avoid a collision.

Advantageously, light guide 30 is located horizontally between stirrer wheel 24 and a corner 42 of recess 14, which makes the design of the device more compact.

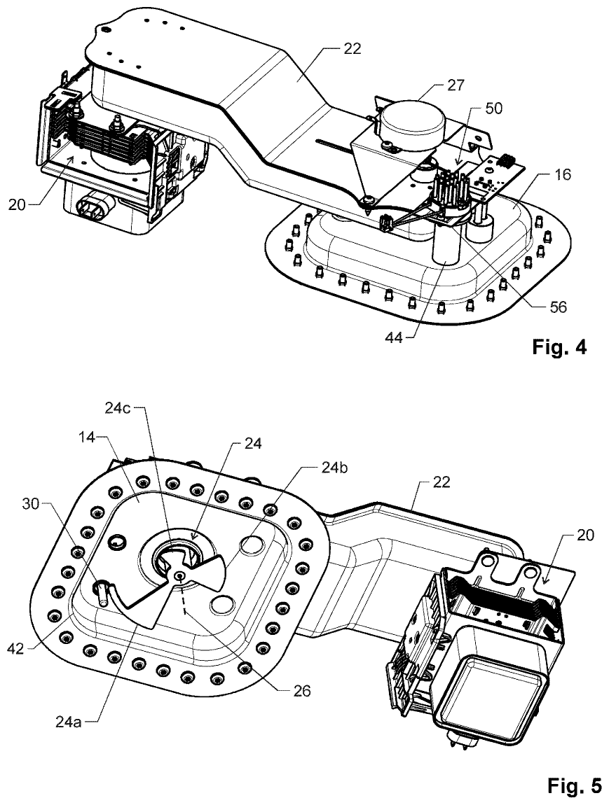

As best shown in FIGS. 7 and 4, the oven comprises a metallic shield member 44 connected to rear wall 16. Light guide 30 extends through an opening 46 in shield member 44.

As described above, shield member 44 surrounds light guide 30 for a length L along the axial direction of light guide 30. Length L is chosen to be sufficiently large to suppress a significant leakage of microwave radiation. As it will be clear to the skilled person, length L depends i.a. on the diameter of opening 46, the average dielectric constant in opening 46 (which is primarily defined by the dielectric constant of the material of light guide 30), the wavelength of the microwave radiation, and the conductance of the metal of shield member 44.

Advantageously, length L is at least 1 cm, in particular at least 3 cm.

Diameter D of opening 46 is advantageously less than 1 cm.

In the shown embodiment, light source 28 is mounted to the top end of shield member 44, thereby making it easy to properly align light source 28 and light guide 30.

Light source 28 forms part of an illumination assembly 50, which comprises a substrate 52 and cooling fins 54, with light source 28 being attached to substrate 52.

A mounting plate 56, which is advantageously a part separate from shield member 44, is mounted to the top end of shield member 44, e.g. by means of screws 58. Shield member 44 extends between rear wall 16 of cavity 16 and mounting plate 56, thereby holding mounting plate 56 in position relative to cavity 14.

Illumination assembly 50 and therefore light source 28 are mounted to mounting plate 56 on the side facing away from chamber 6, i.e. on the top side of mounting plate 56.

Mounting plate 56 comprises an opening 60 located between light source 28 and the light-source-facing end 31 of light guide 30 to provide a passage of the light.

Illumination assembly 50 comprises an anchor 62 that releasably engages opening 60. By mounting light source 28 by means of a releasable anchor, light source 28 can be swapped easily.

Anchor 62 may e.g. be formed by two or more arms extending below the edge of opening 60. Advantageously, the arms are elastically biased against the edge of opening 60 for centering the light source.

For example, anchor 62 and opening 60 may form a bayonet-type connection.

As seen in FIG. 7, stirring wheel 24 is connected to drive 27 by means of a shaft assembly 70 and an elastic coupling 72.

Rotation axis 26 of stirring wheel 24 extends parallel to the longitudinal axis of light guide 30.

### Second Embodiment

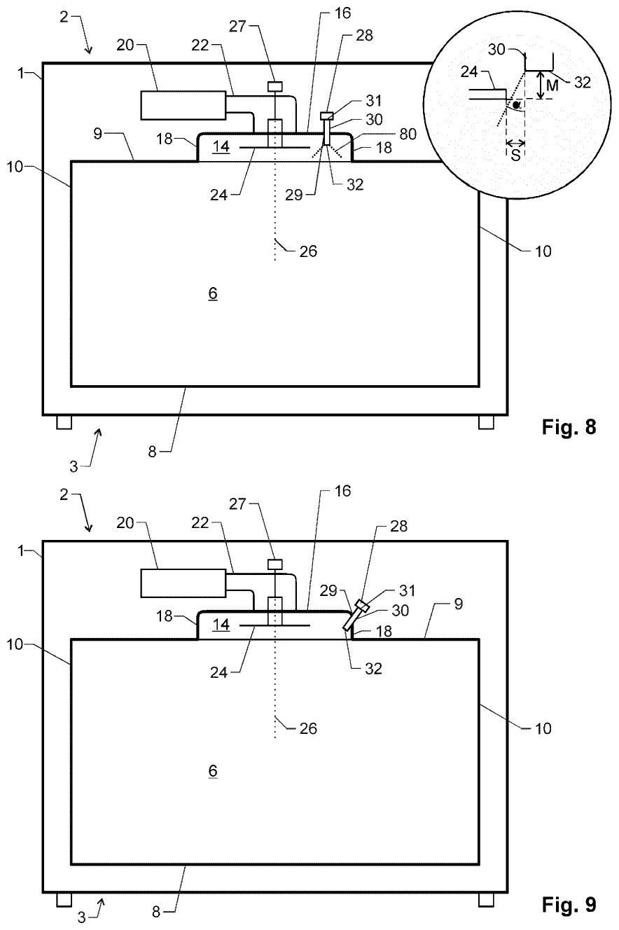

FIG. 8 schematically shows a second embodiment of the device where the chamber-facing end 32 of light guide 30 is located slightly deeper in the recess than the blades of stirrer wheel 24. As can be seen, however, the exit cone 80 of the light emerging from light guide 30 is located such that it does not intersect with the blades of stirrer wheel 24.

In particular, and as shown in the circular inset in FIG. 8, if
S defines the closest distance, in a direction perpendicular to the exit axis of the light guide, between the peripheral ends of the blades of stirrer wheel 24 and chamber-facing end 32,
a is the aperture angle of light cone 80, and
M is the distance, along the axial exit direction of the light guide, between chamber-facing end 32 and the closest part of stirrer wheel 24,
   the following condition is advantageously fulfilled

$$S / M > tan ( α ) ,$$

$$i . e .$$

$$M < S / tan ( α )$$

In other words, the distance M can be larger if the aperture of light cone 80 is small.

### Third Embodiment

FIG. 9 finally illustrates an embodiment where opening 29 is located in a lateral wall 18 of recess 14.

Still, and as shown, opening 29 is located deeper than the blades of stirrer wheel 24, i.e. light guide 30 is used to carry the light past the stirrer wheel.

### Notes

Even though the above embodiments have only a single light source 28 and a single light guide 30, the microwave oven may also comprise several such light sources and/or light guides.

Light source 28 is advantageously an LED, in particular a white-light LED.

The chamber-facing end 32 of light guide 30 is typically at a distance of at least 3 cm from the opening 29 where light guide 30 passes through rear wall 16 into recess 14, i.e. light guide 30 projects deep into recess 14 in order to provide room for stirring wheel 24.

Advantageously, chamber-facing end 32 of light guide 30 is located at a distance from transparent plate 38 in order to let the light spread before it reaches diffusor 40. This distance is, advantageously, at least 0.5 cm.

In the embodiments above, the chamber-facing end 32 of light guide 30 is located closer to chamber 6 than any parts of stirrer wheel 24. However, chamber-facing end 32 may also, as mentioned for the second embodiment, be located slightly deeper than (i.e. further away from chamber 6 than) the closest peripheral parts of the blades of stirrer wheel 24 as long as the light emitted from chamber-facing end 32 does not directly hit stirrer wheel 24. However, locating chamber-facing end 32 at least as close to chamber 6 as stirrer wheel 24 is advantageous because it allows to use a larger light aperture and therefore to better distribute the light that goes into chamber 6.

As e.g. seen in FIG. 7, light guide 30 is located at a distance A from any of the lateral walls 18 of recess 14, which renders manufacturing easier. In other words, the recess 14 comprises lateral side walls 18 connecting rear wall 16 to the closest side chamber wall 9 of chamber 6. The closest distance A between light guide 30 and any of the lateral walls 18 is at least 1 cm, in particular at least 2 cm.

As also shown in FIG. 7, the chamber-facing end 32 of light guide 30 is at a distance from the edge 15 of recess 4, with the “edge” defined as the edge of the transparent region where recess 14 and chamber 6 meet, i.e. the part that may cast a shadow for the light emanating from light guide 30. In the embodiment of FIG. 7, this distance corresponds to the distance A. By keeping the chamber-facing end 32 of light guide 30 away from this edge, a more homogeneous illumination can be achieved. In other words, the closest distance A between the chamber-facing end 32 of light guide 30 and the edge 15 of recess 14 is at least 1 cm, in particular at least 2 cm. This distance is measured along the direction perpendicular to axis 16.

As shown, light guide 30 advantageously extends in a vertical direction, but it may also be inclined in respect to the vertical direction.

The recess 14 is, in the shown embodiments, located in the top chamber wall of chamber 6. However, it may, in other embodiments, also be located in the rear chamber wall or one of the side chamber walls 10, in which case the depth direction T extends horizontally.

Advantageously, the light guide has circular cross section. It may, however, also have another cross section, such as an oval cross section or a polygonal cross section.

While there are shown and described presently preferred embodiments of the invention, it is to be distinctly understood that the invention is not limited thereto but may be otherwise variously embodied and practiced within the scope of the following claims.

1. A microwave oven comprising
a foodstuff chamber,
a recess arranged in a chamber wall of the chamber, wherein the recess has a rear wall on a side opposite to said chamber and side walls connecting the rear wall to the chamber, wherein a direction perpendicular to the chamber wall defines a depth direction, with the rear wall located deeper than the chamber wall,
a microwave generator connected to the recess,
a light source, and
a stirrer wheel arranged in the recess between the rear wall and the chamber, wherein the stirrer wheel is rotatable around an axis,
wherein the oven further comprises a light guide extending from the light source through at least one of
an opening in the rear wall and
at least one of the side walls into the recess,
wherein the opening is located at the same depth as or deeper than the stirrer wheel,
and wherein a chamber-facing end of the light guide is located such that an exit cone of light emerging from the light guide does not intersect with a motion of the stirrer wheel.

2. The microwave oven of claim 1 wherein the opening is located in the rear wall.

3. The microwave oven of claim 1 wherein the light guide extends, at least within the recess, along a direction parallel to the axis.

4. The microwave oven of claim 1 wherein the light guide is a straight rod extending from the light source into the recess.

5. The microwave oven of claim 1 wherein the stirrer wheel comprises at least one blade rotatable about the axis, wherein the chamber-facing end of the light guide is at least as close to the chamber as the blade(s), in particular at least 1 mm closer to the chamber than the blade(s).

6. The microwave oven of claim 1 wherein the chamber comprises a bottom chamber wall, a top chamber wall, and side chamber walls extending between the bottom chamber wall and the top chamber wall, and wherein the microwave oven further comprises a door forming at least part of one of the side chamber walls, and wherein the recess is located in the top chamber wall.

7. The microwave oven of claim 1 wherein, in an operating position of the oven, the rear wall of the recess extends horizontally.

8. The microwave oven of claim 1 further comprising a transparent cover plate between the chamber and the recess, wherein the cover plate comprises a diffusor for scattering the light from the light guide, and in particular wherein the rear wall extends parallel to the cover plate.

9. The microwave oven of claim 1 further comprising a metallic shield member connected to the rear wall, wherein the light guide extends through an opening in the shield member.

10. The microwave oven of claim 9 wherein the shield member surrounds the light guide for a length of at least 1 cm, in particular at least 3 cm, along an axial direction of the light guide.

11. The microwave oven of claim 9 wherein a diameter of the opening in the shield member is less than 1 cm.

12. The microwave oven of claim 9 wherein the light source is mounted to the shield member.

13. The microwave oven of claim 9 further comprising a mounting plate mounted to the shield member,
wherein the shield member extends between the rear wall and the mounting plate and is connected to the mounting plate,
wherein the light source is mounted to the mounting plate on a side facing away from the chamber, and
wherein the mounting plate comprises an opening between the light source and the light guide.

14. The microwave oven of claim 13 further comprising an anchor releasably engaging the opening in the mounting plate, wherein the light source is mounted to the anchor.

15. The microwave oven of claim 1 wherein the light guide is located between the stirrer wheel and a corner of the recess.

16. The microwave oven of claim 1 wherein the light guide is of a transparent solid.

17. The microwave oven of claim 1 wherein the stirrer wheel is closer to the chamber than the opening through which the light guide enters the recess.

18. The microwave oven of claim 1 wherein a closest distance between the light guide and any of the lateral walls is at least 1 cm.

19. The microwave oven of claim 1 wherein a closest distance between a chamber-facing end of the light guide and an edge of the recess is at least 1 cm.

20. The microwave oven of claim 1 wherein the 30 light guide is located horizontally beside the stirrer wheel in a space between the stirrer wheel and the side walls.

21. A microwave oven comprising a foodstuff chamber,
a recess arranged in a chamber wall of the chamber, wherein the recess has a rear wall on a side opposite to said chamber and side walls connecting the rear wall to the chamber, wherein a direction perpendicular to the chamber wall defines a depth direction, with the rear wall located deeper than the chamber wall, and wherein, in an operating position of the oven, the rear wall of the recess extends horizontally,
a microwave generator connected to the recess,
a light source, and
a stirrer wheel arranged in the recess between the rear wall and the chamber, wherein the stirrer wheel is rotatable around an axis,
wherein the oven further comprises a light guide extending from the light source through at least one of
an opening in the rear wall and
at least one of the side walls into the recess,
wherein the light guide is located horizontally beside the stirrer wheel in a space between the stirrer wheel and the side walls,
wherein the opening is located at the same depth as or deeper than the stirrer wheel,
and wherein a chamber-facing end of the light guide is located such that an exit cone of light emerging from the light guide does not intersect with a motion of the stirrer wheel.
